(19) United States
(12) Patent Application Publication
(10) Pub. No.: US 2024/0318476 A1
(43) Pub. Date: Sep. 26, 2024

(54) HANDLE FOR A VEHICLE DOOR

(71) Applicant: Volvo Truck Corporation, Göteborg (SE)

(72) Inventor: Avinash KN, BANGALORE, KARNATAKA (IN)

(21) Appl. No.: 18/579,563

(22) PCT Filed: Jul. 29, 2021
(86) PCT No.: PCT/EP2021/071256

§ 371 Date: Jan. 16, 2024

(51) Int. Cl. E05B 85/18; B60J 5/04; B60R 13/02; E05B 79/20; E05B 85/12

(52) U.S. Cl. CPC E05B 85/18; B60J 5/0413; B60R 13/0243; E05B 85/12; E05B 79/20

(57) ABSTRACT

A handle for a vehicle door, the handle being configured to be mounted on the inner face of the door. The handle comprises a main portion configured to be grasped by a user for pushing or pulling the door between an open position and a closed position relative to a vehicle frame, the door being held in the closed position by a latch. The handle main portion substantially extends along an axis. The handle further comprises a lever for releasing the latch. The lever is pivotally mounted on the main portion about a pivoting axis which is substantially parallel to the main portion axis, between a rest position and a release position. Thus, the lever is pivotable by the user while grasping the main portion of the handle.

### TECHNICAL FIELD

The invention relates to a handle for a vehicle door.

In particular, the invention can be applied in light, medium and heavy-duty vehicles, such as trucks, buses and construction equipment.

### BACKGROUND

In an industrial vehicle, such as a truck, the cabin has side doors for the driver and the passenger to get in or out. Generally, a handle is mounted on the inner face of the door for the user to grasp, for pushing or pulling the door between an open position and a closed position relative to the vehicle frame. Furthermore, a latch allows holding the door in the closed position, and a lever is provided that the user can actuate to release the latch.

Current arrangements are not fully satisfactory in terms of packaging layout and ergonomics.

### SUMMARY

An object of the invention is to improve the vehicle side door inner arrangement with regard to the handle and release lever.

To that end, according to a first aspect, the invention relates to a handle for a vehicle door, said handle being configured to be mounted on the inner face of said door and comprising a main portion configured to be grasped by a user for pushing or pulling the door between an open position and a closed position relative to a vehicle frame, wherein the door is held in said closed position by a latch, said handle main portion substantially extending along an axis. The handle further comprises a lever for releasing the latch, the lever being pivotally mounted on the main portion about a pivoting axis which is substantially parallel to the main portion axis, between a rest position and a release position, the lever thus being pivotable by the user while grasping the main portion of the handle.

Thus, according to the invention, the lever and the main portion are integrated in the handle as one single assembly.

As compared to conventional arrangements where the handle main portion and the lever are separate units, secured to the door inner face at two different locations, the invention allows greatly improving the door packaging layout, reducing the allocated space, and reducing the production costs. Moreover, as the lever is integrated with the handle main portion, the user can both release the latch and pushing the door without the need to shift his hand from one location to another. As a result, the user comfort level and ergonomics are significantly improved. In addition, having a single assembly in which both functions are integrated makes it possible to enhance the aesthetic appeal.

In an embodiment, in the rest position, the lever is arranged substantially level with a wall of the main portion. In the release position, the lever can protrude outwardly from a wall of the main portion.

Thus, when a user wants to switch the lever from the rest position to the release position, he must move the lever away from the wall of the main portion. As a result, the lever cannot be accidentally moved to its release position, contrary to an arrangement in which switching the lever to its release position would require the lever to be moved towards the wall of the main portion. Indeed, such a movement could be unintentionally performed by a user grasping the handle main portion.

The handle main portion may have a peripheral wall which comprises an opening, the lever being mounted in the opening

In the rest position, the lever can extend in the opening while leaving a gap between the lever and the peripheral wall which surrounds the opening, for allowing the user to insert his fingers in said gap for moving the lever to the release position. Said gap is preferably opposite the pivoting axis, which makes the lever operation easier.

In an embodiment, the lever is mounted on the outer side of the main portion, which is the side intended to be positioned facing the door when the handle is mounted on the inner face of said door.

As a consequence, the lever is hidden from view, which improves the aesthetics of the handle. Moreover, the lever is less likely to be accidentally caught in a surrounding element, which could cause unintentional unlocking of the door. In addition, with such an arrangement, the user can grasp the handle main portion to move the door and, if required, move the lever to the release position (for example with his fingers) without the need for him to move his hand from one location to another. This is thus more convenient and improves the user's comfort.

The handle may further comprise a biasing member for biasing the lever towards its rest position.

In an embodiment, the lever comprises:
a main wall;
an arm extending from the main wall towards an internal area of the handle main portion, said arm having an attachment portion for attaching an actuator of the door latch.

The handle may further comprise a gear arrangement which links the lever main wall and the lever arm, so that the movement of the lever from its rest position to its release position results in a pivoting movement of the attachment portion about an axis which is orthogonal to the main portion axis, and ultimately to a pulling movement of the door latch actuator, for example substantially along the main portion axis.

In an embodiment, the pivoting movement of the attachment portion is about a vertical axis, in the mounted position. In practice, the door latch actuator can be a cable which is pulled away from the latch. The gear arrangement can form or be part of the biasing member configured to bias the lever towards its rest position, for example as a result of the pulling action of the cable back towards the latch.

The lever may comprise two opposite lugs, each lug being configured to be engaged (for example snapped) into a notch of the handle main portion, so as to form the pivoting axis.

According to a second aspect, the invention relates to a door for a vehicle, comprising:
a door body;
a door trim secured to the door body on the inner face thereof;
a latch attached to the door body, and configured for holding the door in a closed position relative to a frame of the vehicle;
a handle as previously described, wherein the handle main portion is secured to the door body and the lever is attached to an actuator of the latch.

The door can typically be a side door of a cabin of an industrial vehicle such as a truck.

In an embodiment, the door trim comprises a recess and the handle is substantially housed in said recess. The axis of the main portion may be substantially longitudinal, with reference to the vehicle longitudinal direction in the mounted position of the door.

In an embodiment, the latch actuator comprises a cable which is attached to the lever so that when the lever is pivoted from its rest position to its release position, the lever pulls the cable.

According to a third aspect, the invention relates to a vehicle, in particular an industrial vehicle such as a truck. The vehicle comprises a frame and a door as previously described, the door being pivotally mounted on the vehicle frame between an open and a closed position. In the closed position, the door can be in a latched state or in an unlatched state.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective view of the interior of a vehicle cabin, showing a door comprising a handle according to an embodiment of the invention;

FIG. 2 is a perspective view of a door body, showing its inner face;

FIG. 3 is a partial plane view of the door of FIG. 1;

FIG. 4 is a perspective view of the handle, showing its outer face;

FIG. 5 is a partial horizontal cross section view of the door and handle, showing a handle main portion and a lever;

FIG. 6 is a partial perspective view from the inside of the handle main portion, showing the lever;

FIG. 7 is a partial perspective view of the handle, showing the lever in a rest position and in a release position;

FIG. 8 is a view similar to FIG. 5, with a different orientation;

FIG. 9 is a partial perspective view of another embodiment of the handle, showing the lever in a rest position;

FIG. 10 is a view similar to FIG. 9, the lever being in its release position.

### DETAILED DESCRIPTION OF EXAMPLE EMBODIMENTS OF THE INVENTION

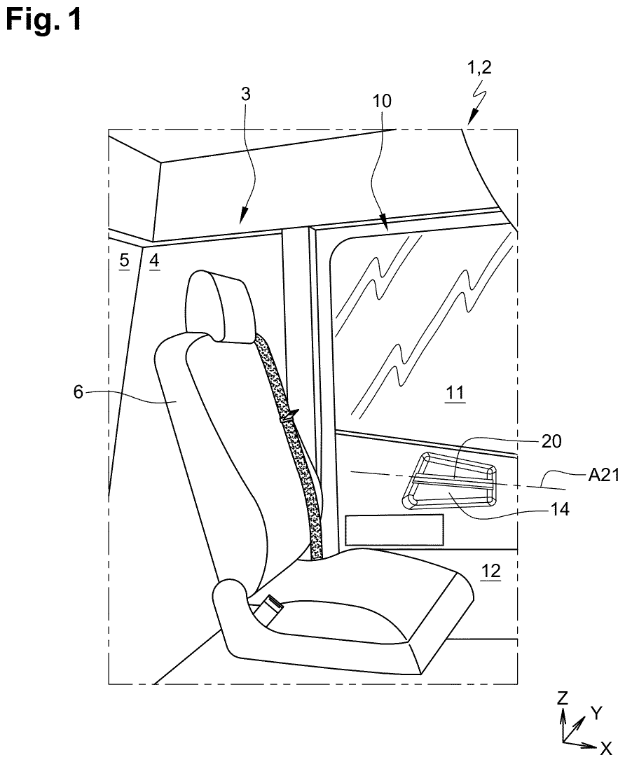

FIG. 1 shows the interior of a cabin 2 of a vehicle 1 such as a truck.

Z is defined as the vertical direction, X is defined as the longitudinal direction of the vehicle 1, and Y is defined as the transversal direction of the vehicle 1. The term “inner” refers to elements that are located closer to the vehicle longitudinal median plane, as opposed to the term “outer”.

The vehicle cabin 2 comprises a frame 3 which includes a front wall, two side walls, namely a right side wall and a left side wall 4, and a rear wall 5. The cabin 2 forms a driver compartment. It comprises at least one seat 6 for the driver, and can also comprise an additional seat (not shown) for a possible passenger.

Each side wall 4 of the cabin frame 3 has an aperture that can be closed by a door 10. The door 10 is pivotally mounted on the frame 3 between an open and a closed position. For example, the door 10 can be mounted on the frame 3 by means of a hinge 7 located near a door front vertical edge.

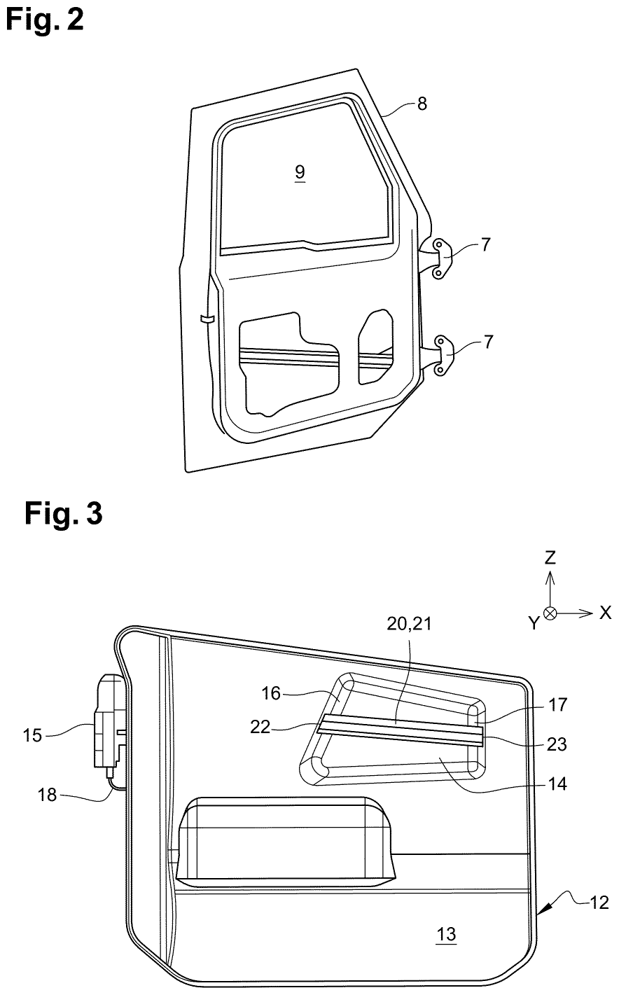

The door 10 includes a door body 8 generally made of metal, and which forms an outer panel, as shown in FIG. 2. The upper part of the door body 8 may comprise an opening 9 in which is mounted a glass panel 11 that forms a window. The door body 8 also comprises a lower part 12 to which various components can be secured. The lower part 12 includes a door trim 13 secured to the door body 8 on the inner face thereof. The door trim 13 thus forms an internal covering which is generally made of plastic.

The door 10 further comprises a latch 15 attached to the door body 8. The latch 15 is configured for holding the door 10 in its closed position relative to the frame 3. Therefore, in the closed position, the door 10 can be in a latched state or in an unlatched state.

As shown in FIG. 3, which represents the door lower part 12, the latch 15 can be located near the edge of the door 10 opposite the hinge, for example the door rear edge.

The door 10 further comprises a handle 20, which is mounted on the inner face of the door 10.

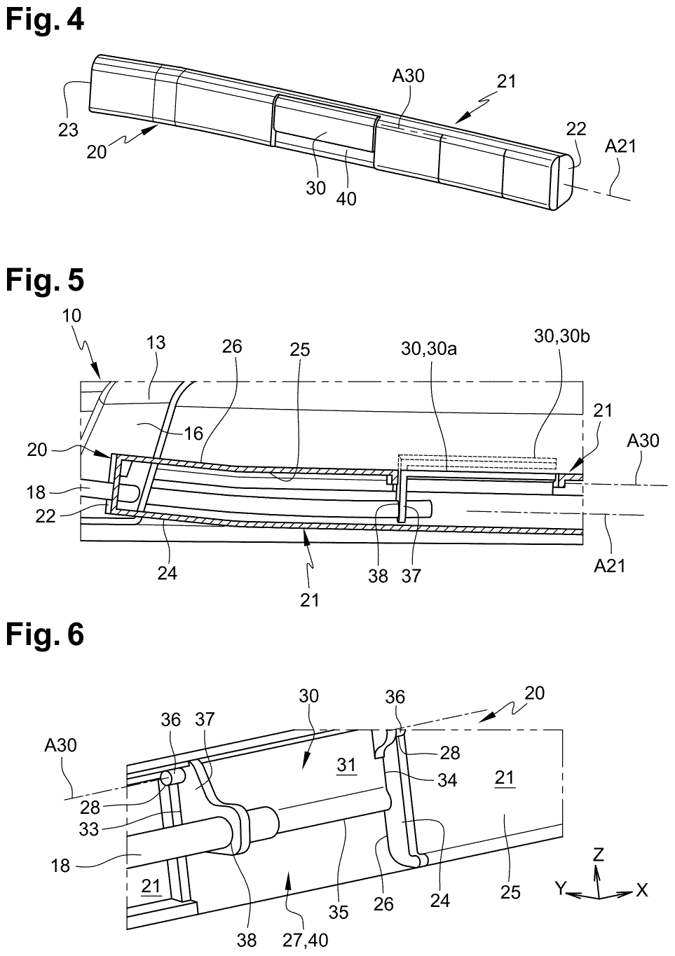

As shown in FIG. 4, the handle 20 comprises a main portion 21 which is configured to be grasped by a user for pushing or pulling the door 10 between its open position and its closed position. The main portion 21 extends substantially along an axis A21. In other words, the main portion 21 can have an overall shape that is elongated. In the mounted position, the axis A21 of the main portion 21 can be substantially longitudinal, i.e. parallel to direction X.

The main portion 21 is secured to the door body. In an embodiment, the door trim 13 comprises a recess 14 and the handle 10 is substantially housed in said recess 14. For example, the recess 14 has a rear face 16 and a front face 17, the rear end 22 of the handle main portion 21 being attached to the recess rear face 16 and the front end 23 of the handle main portion 21 being attached to the recess front face 17. It has to be specified that, even if the handle 10 is attached to the door trim 13, it is further secured to the door body 8 for carrying loads.

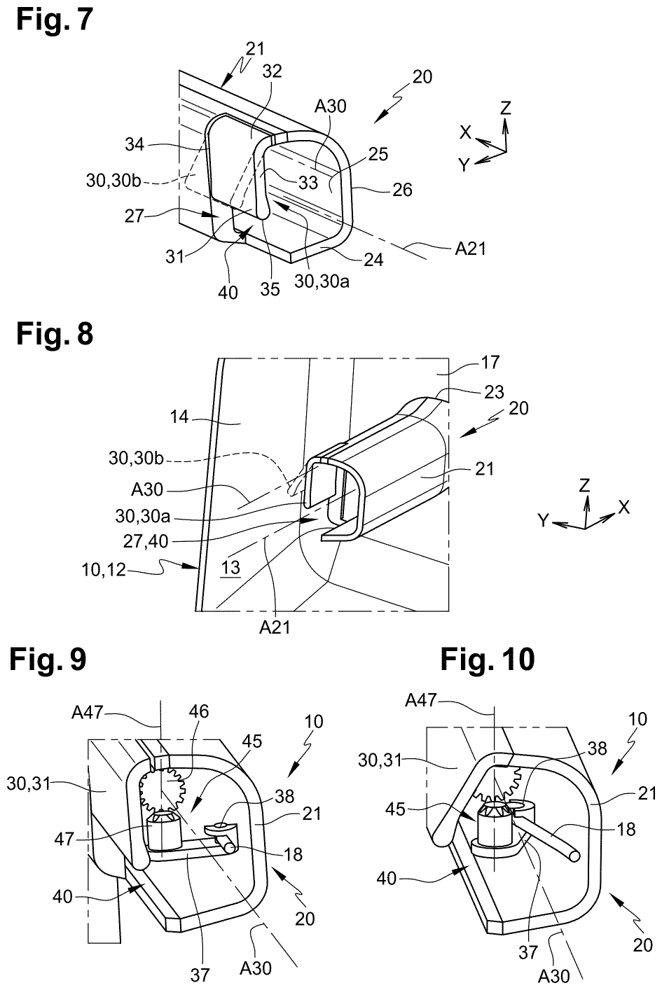

The handle main portion 21 may be a hollow piece. In a non-limiting embodiment, the handle main portion 21 can form substantially a hollow cylinder. The handle main portion 21 can have a peripheral wall 24 having an internal face 25 and an external face 26, as best seen in FIG. 7.

The handle 20 further comprises a lever 30 for releasing the latch 15. The lever 30 is pivotally mounted on the main portion 21 about a pivoting axis A30 which is substantially parallel to the main portion axis A21, between a rest position and a release position. In other words, in the mounted position, the lever pivoting axis A30 can be substantially longitudinal. Thus, the lever 30 is pivotable by the user while grasping the main portion 21 of the handle 20.

In an embodiment, the peripheral wall 24 of the handle main portion 21 comprises an opening 27, preferably on the outer side of the main portion 21, which is the side that faces the door trim 13. With such an arrangement, the lever 30 can be mounted in the opening 27, as shown in FIGS. 7 and 8.

For example, the lever 30 comprises a main wall 31 that can be substantially planar and that can be arranged in a plane (X,Z). The lever 30 may further comprise an extension 32 that is substantially orthogonal to the main wall 31 with a curved junction.

In the rest position, the lever 30 may be arranged substantially level with a wall of the main portion 21. More specifically, as shown in FIG. 7, the main wall 31 may be level with the outer side of the main portion peripheral wall 24 while the extension 32 may be level with the upper side of the main portion peripheral wall 24. Furthermore, in said rest position, the main wall 31 and extension 32 may have a rear edge 33 and a front edge 34 which are parallel to and adjacent respectively the rear edge and the front edge that delimit the opening 27.

The lever pivoting axis A30 can be located near the extension 22.

Besides, the edge of the lever 30 opposite the pivoting axis A30, which here is the lower edge 35, may be arranged at a distance of the facing edge of the opening 27, in the rest position. In other words, with such a non-limiting arrangement, in said rest position, the lever 30 extends in the opening 27 while leaving a gap 40 between the lever 30 and the main portion peripheral wall 24 which surrounds the opening 27.

In an embodiment, the lever 30 comprises two opposite lugs 36 which may extend respectively from the rear edge 33 and front edge 34 of the lever in opposite directions. Each lug 36 is configured to be engaged into a notch of the handle main portion 21 so as to form the pivoting axis A30 of the lever 30.

The lever 30 may further comprise an arm 37 extending from the main wall 31 towards an internal area of the handle main portion 21. The arm 37 can be orthogonal to the lever main wall 31; it can be located near the rear edge 33 of the main wall 31 and extension 32. The arm 37 has an attachment portion 38 for attaching an actuator 18 of the door latch 15. The latch actuator 18 may comprise a cable.

When not actuated upon, the lever 30 is in its rest position illustrated in solid lines in FIGS. 5, 7 and 8, the lever then bearing reference 30a. There may be provided a biasing member for biasing the lever 30 towards its rest position.

When the door 30 is in the latched state and a user inside the cabin 2 wants to open the door 30, he grasps the handle 20 and moves the lever 30 to the release position by imparting a pivoting movement around axis A30. This results in the latch 15 being released, the door 10 thus being in the unlatched state. The user can then push the door 10 to move it towards its open position relative to the frame 3.

Owing to the invention, the first step, namely the release operation by actuating the lever 30, and the second step, namely the door opening by pushing the handle main portion 21, can be performed by the user without moving his hand on the handle 20. Integrating both functions in a single unit therefore makes the operation easier, and greatly improves the user's comfort.

More specifically, with the non-limited embodiment previously described, the user can insert his fingers in the gap 40 arranged between the lever 30 and the main portion 21. Thus, as a first step, the user can pull the lever 30 from the inside of the handle main portion 21, make it pivot around axis A30, and thus move the lever 30 to the release position. As shown in FIGS. 5, 7 and 8 in dotted lines, in the release position, the lever 30 (which then bears reference 30b) may protrude outwardly from a wall of the main portion 21, namely from an outer side of the main portion peripheral wall 24 towards the door trim 13.

Such a pivoting of the lever 30, from its rest position to its release position, results in the lever 30 pulling the cable 18 and thus in the latch 15 being released. Indeed, from the rest position shown in FIG. 6 and in solid lines in FIG. 7, when the lever 30 is pivoted about axis A30, the lower portion of the main wall 31 is moved away from of the handle main portion 21, towards the outside, as shown in dotted lines in FIG. 8. Thus, the arm 37 of the lever 30 is moved according to the same movement. As the cable 18 is secured to the arm 37 at attachment portion 38, this results in the cable 18 being moved along axis X, away from the latch 15, which causes the latch release.

FIGS. 9 and 10 shows an embodiment of the invention in which the handle 10 comprises a gear arrangement 45 which links the lever main wall 31 and the lever arm 37. More specifically, the gear arrangement 45 may include a first gear 46 having an axis substantially coincident with the lever pivoting axis A30 and a second gear 47 having an axis A47 substantially parallel to Z, wherein the second gear 47 meshes with the first gear 46. The first gear 46 is mounted on the lever 30 such that the pivoting movement of the lever main wall 31 results in the rotation of the first gear 46 about the lever pivoting axis A30. Consequently, the second gear 47 rotates about axis A47. As the arm 37 is secured to the second gear 47, the arm 37 and attachment portion 38 also rotate about axis A47, resulting in the cable 18 being pulled away from the latch 15, substantially along the main portion axis A21.

The lever 30 may be arranged in the middle third of the handle 20, along longitudinal direction X, as shown in FIG. 4. However, other implementations can be envisaged to improve ergonomics, depending on the area of the door trim 13 to which the handle 20 is secured, relative to the seat 6.

Having the lever 30 arranged on the outer side of the handle 20 results in the lever 30 being hidden between the handle 20 and the door 10. This makes the handle 20 very aesthetically appealing, and also greatly reduces the risks of unintentionally releasing the latch 15.

The handle 20 may be made of aluminium or a plastic material, for example.

It is to be understood that the present invention is not limited to the embodiments described above and illustrated in the drawings; rather, the skilled person will recognize that many changes and modifications may be made within the scope of the appended claims.

1. A handle for a vehicle door, the handle being configured to be mounted on the inner face of the door and comprising:
a main portion configured to be grasped by a user for pushing or pulling the door between an open position and a closed position relative to a vehicle frame;
wherein the door is held in the closed position by a latch, the handle main portion substantially extending along an axis;
wherein the handle further comprises a lever for releasing the latch, the lever being pivotally mounted on the main portion about a pivoting axis which is substantially parallel to the main portion axis, between a rest position and a release position, the lever thus being pivotable by the user while grasping the main portion of the handle.

2. The handle of claim 1, wherein, in the rest position, the lever is arranged substantially level with a wall of the main portion.

3. The handle of claim 1, wherein, in the release position, the lever protrudes outwardly from a wall of the main portion.

4. The handle of claim 1, wherein the handle main portion has a peripheral wall which comprises an opening, the lever being mounted in the opening.

5. The handle of claim 4, wherein, in the rest position, the lever extends in the opening while leaving a gap between the lever and the peripheral wall which surrounds the opening, for allowing the user to insert his fingers in the gap for moving the lever to the release position.

6. The handle of claim 1, wherein the lever is mounted on the outer side of the main portion, which is the side intended to be positioned facing the door when the handle is mounted on the inner face of the door.

7. The handle of claim 1, further comprising a biasing member for biasing the lever towards its rest position.

8. The handle of claim 1, wherein the lever comprises:
a main wall; and
an arm extending from the main wall towards an internal area of the handle main portion, the arm having an attachment portion for attaching an actuator of the door latch.

9. The handle of claim 8, further comprising a gear arrangement which links the lever main wall and the lever arm, so that the movement of the lever from its rest position to its release position results in a pivoting movement of the attachment portion about an axis which is orthogonal to the main portion axis, and ultimately to a pulling movement of the door latch actuator, for example substantially along the main portion axis.

10. The handle of claim 1, wherein the lever comprises two opposite lugs, each lug being configured to be engaged into a notch of the handle main portion, so as to form the pivoting axis.

11. A door for a vehicle, comprising:
a door body;
a door trim secured to the door body on the inner face thereof;
a latch attached to the door body, and configured for holding the door in a closed position relative to a frame of the vehicle; and
the handle of claim 1, wherein the handle main portion is secured to the door body and the lever is attached to an actuator of the latch.

12. The door of claim 11, wherein the door trim comprises a recess, the handle being substantially housed in the recess.

13. The door of claim 11, wherein the axis of the main portion is substantially longitudinal, with reference to the vehicle longitudinal direction in the mounted position of the door.

14. The door of claim 11, wherein the latch actuator comprises a cable which is attached to the lever so that when the lever is pivoted from its rest position to its release position, the lever pulls the cable.

15. A vehicle, in particular an industrial vehicle such as a truck, comprising a frame and the door of claim 11, the door being pivotally mounted on the vehicle frame between an open and a closed position, wherein in the closed position, the door can be in a latched state or in an unlatched state.
